(19) United States
(12) Patent Application Publication
(10) Pub. No.: US 2003/0107947 A1
(43) Pub. Date: Jun. 12, 2003

(54) Device for mixing viscous liquids

(76) Inventor: Zsolt Herbak, Bad Wildbad-Calmbach (DE)

Correspondence Address: RABIN & CHAMPAGNE, PC, 1101 14TH STREET, NW, SUITE 500, WASHINGTON, DC, 20005, US

(21) Appl. No.: 10/149,669

(22) PCT Filed: Dec. 9, 2000
(86) PCT No.: PCT/DE00/04386

(30) Foreign Application Priority Data
Dec. 14, 1999 (DE) 199 60 202.6

(51) Int. Cl. B01F 15/02

(52) U.S. Cl. 366/162.5

(57) ABSTRACT

A device for mixing viscous liquids, comprising a cylindrical mixing chamber (100) that is open on one front and has a side wall, at least two injection nozzles (170), the nozzle openings of which are provided with exit bores (105B) in the side wall, and a piston (150) that can be displaced inside the mixing chamber (100) in axial direction, along the longitudinal axis (A-A) of the mixing chamber (100) and which has a circular surface. A motor (135) (FIG. 1) can move the piston in axial direction as well as rotate it around its longitudinal axis inside the mixing chamber (100).

### TECHNICAL FIELD

The invention relates to a device for mixing viscous liquids in accordance with the preamble to claim 1, as well as a method for using a device of this type.

### PRIOR ART

Devices of the type as defined in the preamble are known from prior art and are used, for example, in the synthetics industry for mixing together two components, which then react and form the end product such as synthetic foam. In principle, two different devices are known for this.

In order to mix highly viscous liquids, these are injected with respectively two nozzles into a primarily cylindrical reaction chamber and are then mixed with the aid of stirring mechanisms. The liquids, which should be mixed as homogeneously as possible, are then discharged from the reaction chamber through a lower end that is open. These types of devices are suitable only for a continuous operation since both liquids frequently react extremely fast and cause the stirring mechanisms to stick together if the production is interrupted. As soon as the mixture is hardened and becomes rigid, the reaction chamber cannot be cleaned or only with great expenditure to become operational once more.

Furthermore known is the process of injecting two highly viscous liquids with the aid of two high-pressure pumps into a mostly cylindrical reaction chamber, wherein the jets intermix in a counter-stream injection method. These types of devices are mostly provided with pistons, for which the axial stroke makes it possible to clean the mixing chamber of the remaining liquids during production stops. These arrangements have the advantage that they can also be used for the discontinuous operation. However, they cannot be used with highly viscous liquids because they lack a stirring mechanism.

### SUMMARY OF THE INVENTION

Starting with this prior art, it is the object of the invention to create a device for mixing liquids, which is also suitable for use with highly viscous liquids, but can nevertheless be operated in the discontinuous mode. In particular, this device should be suitable for mixing highly viscous liquids which, when mixed together, form a solid plastic or synthetic foam after short reaction times.

This object is solved with a device having the features as listed in claim 1.

Claim 9 describes the use of a device as defined in the above.

The basic idea behind the invention is to modify the counter-stream mixing head described in the above, such that the piston which is axially displaceable used for cleaning purposes can be rotated around its own axis inside the cylindrical mixing chamber, thus generating a stirring movement.

One particularly advantageous embodiment is a device according to claim 3. With this device, stirring rods can be used and can be cleaned automatically.

According to claim 10, the axial degree of freedom of the piston is furthermore used for a better mixing of the components.

Additional advantageous embodiments follow from the additional dependent claims.

### BRIEF DESCRIPTIONS OF THE INVENTION

In the following, the invention is explained in further detail using an exemplary embodiment and with reference to the drawings, which show in:

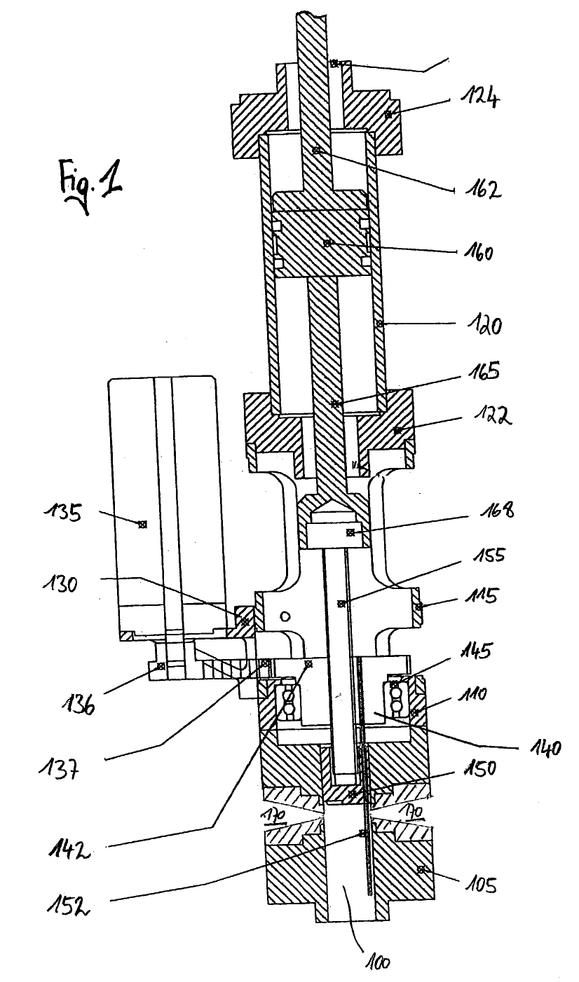

FIG. 1A longitudinal section through a device according to the invention in a first operating position.

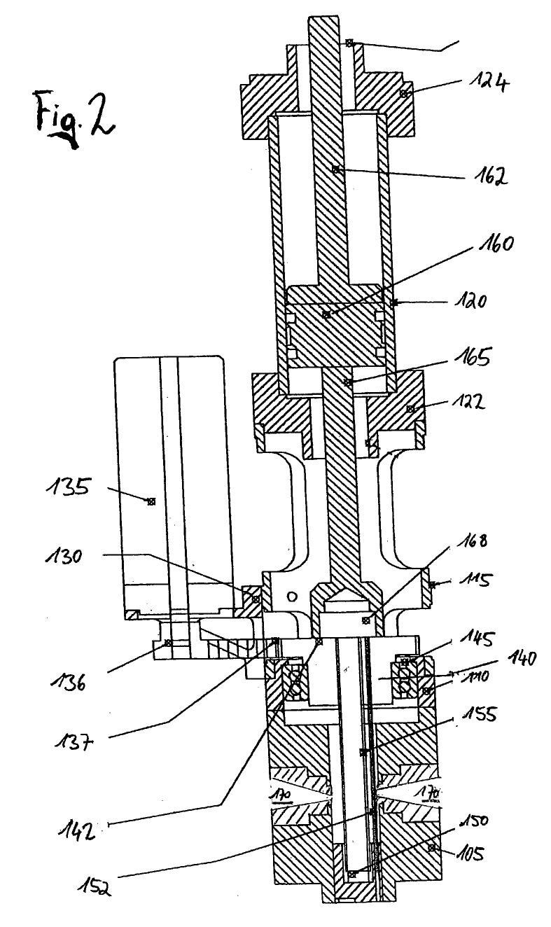

FIG. 2 The device from FIG. 1 in a second operating position.

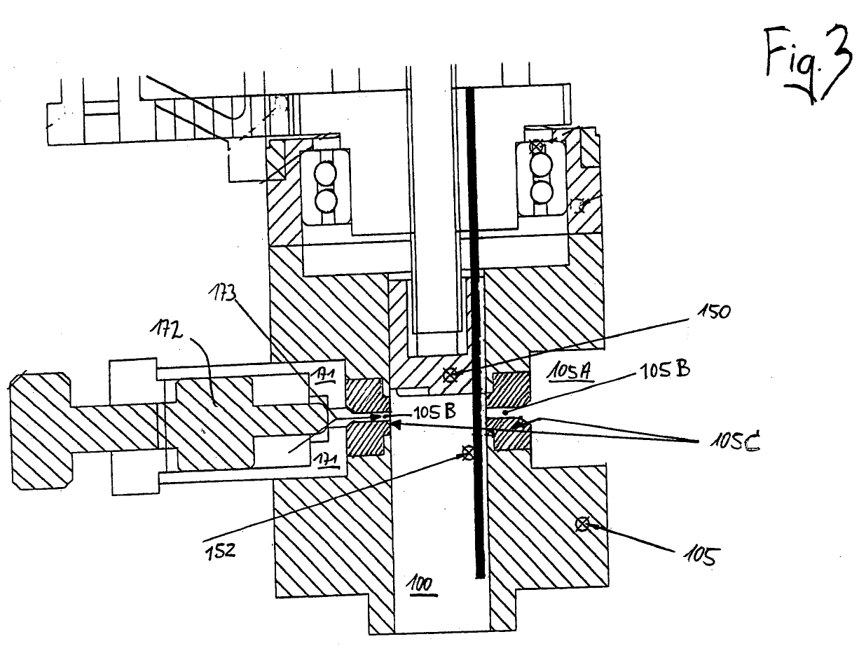

FIG. 3A cross section through the mixing chamber

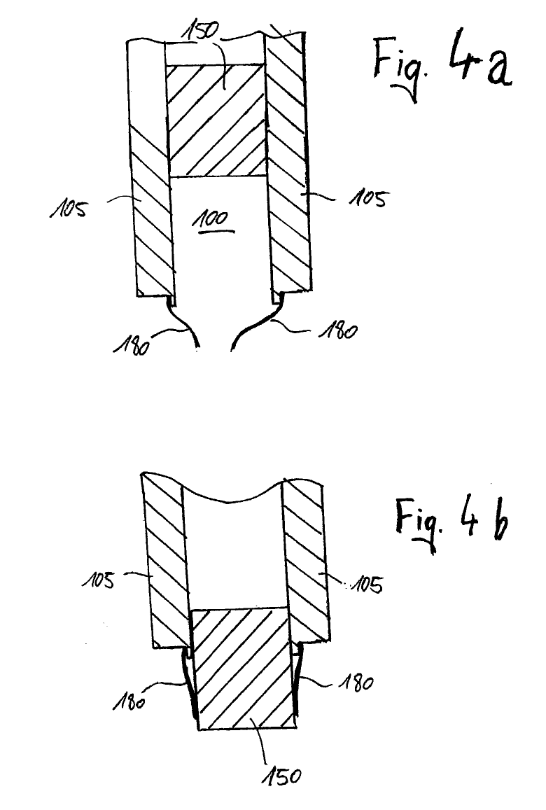

FIGS. 4A and B Schematically a modification of the invention.

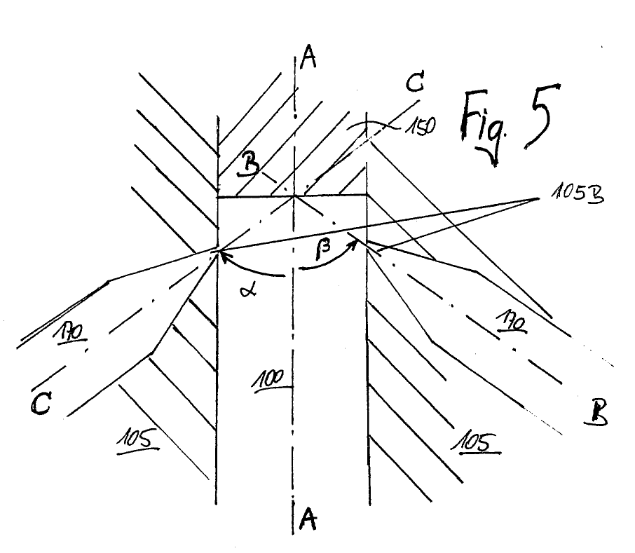

FIG. 5 Schematically an additional exemplary embodiment.

### DETAILED DESCRIPTION OF PREFERRED EMBODIMENTS

FIG. 1 shows a cross-section through a device according to the invention. The mixing chamber housing 105 contains a cylindrical mixing chamber 100, in which the piston 150 is positioned axially displaceable. The piston 150 is displaced in axial direction by means of a hydraulic piston 160, positioned inside the hydraulic cylinder 120. The hydraulic piston 160 is rigidly connected to the hydraulic rod 165, which carries the first ball bearing 168 at its lower end. The splined shaft 155 is held at the inner ball bearing race 168, so that the hydraulic rod 165 and the splined shaft 155 are axially coupled, but are decoupled with respect to the rotational movement around the axis A-A. The splined shaft 155 extends through the coupling element 140, thus connecting the coupling element 140 and the splined shaft 155 when performing the rotational movement. The piston 150 that is arranged inside the mixing chamber 100 is attached to the end of the splined shaft 155.

The above-mentioned coupling element 140 is connected by means of the second ball bearing 145 to the bearing flange 110, which in turn is flanged rigidly to the mixing-chamber housing 105. The gear rim 142 is positioned on the outside of coupling element 140, which has an essentially symmetrical design with respect to axis A-A. The gear rim 142 and thus also the coupling element 140 can be driven with motor 135. Attached to the shaft of motor 135 is the gear wheel 136, which is connected via the toothed belt 137 to the gear rim 142. Via the console 130, the motor 135 is flanged to the lantern 115 or the bearing flange 110.

The stirring rod 152 is arranged on the coupling element 140 and extends parallel to the axis A-A in the mixing chamber 100, wherein it also extends through the piston 150.

The two nozzles 170 through which the two viscous liquids to be mixed are pushed into the mixing chamber 100 are arranged inside the mixing chamber housing 105. FIGS. 1 and 2 show the two nozzles 170 only schematically.

FIG. 3 shows the possible design for these nozzles 170. The mixing chamber housing 105 contains two recesses 105A, into which respectively one nozzle body 171 is inserted (only one nozzle body 171 is shown here). The high pressure, which builds up externally, is adjusted inside the nozzle body 171 by means of an injection piston 172 and the liquid is squeezed out of the nozzle body 172 through the nozzle body opening 173. Arrangements of this type are known in the technical field and are not described in further detail herein. The actual nozzle openings in this case are the exit bores 105B of hardened nozzle tips 105C inside the mixing chamber housing 105. The nozzle body can also conceivably extend up to the mixing chamber, so that the frontal part of the nozzle body forms a part of the side wall of the mixing chamber. The nozzle body opening and the exit bore in the nozzle tip would then be identical.

The principle mode of operation for the device is described in the following.

FIG. 1 shows the first operational position for the device. The piston 150 in this case is located above the nozzle openings for nozzles 170. In this position, the liquids to be mixed are injected through the nozzles 170 into the mixing chamber 100. The injection normally occurs under high pressure, meaning with injection pressures above 100 bar. During the injection operation, the motor 135 starts the rotation of coupling element 140 and thus also the piston 150 and the stirring rod 152. Owing to the rotation of piston 150 and the stirring rod 152, highly viscous liquids can also be mixed together. The mixed liquids are discharged to the outside at the lower end of the mixing chamber 100.

Following the completion of the mixing operation, the supply of the two liquids through the nozzles 170 is turned off. Subsequently, the piston 150 is pushed axially downward inside the mixing chamber 100 (see FIG. 2) by subjecting the hydraulic piston 160 to pressure. As a result, all residues are pushed from the mixing chamber 100 and the mixing chamber 100 cleaned in this way. The stirring rod 152 is stripped off at the same time and thus cleaned. If the production is to be restarted, the piston 150 is again pulled back into the position shown in FIG. 1 and the cycle can begin anew.

Several optional designs for the device according to the invention are shown in the following:

According to FIGS. 4A and B, a flexible mouthpiece 180 can be installed on the open end of the mixing chamber 100, meaning where the finished mixture leaves the mixing chamber. The mouthpiece 180 is preferably designed to taper downward in the non-stressed condition and in particular forms an elongated opening slot. This can be an advantage if the mixed mass must be released in a controlled manner. In that case, the axial stroke of piston 150 must be enough to penetrate the mouthpiece 180 over its complete length. As a result of the flexible qualities of the mouthpiece 180, it adjusts to the form of the piston 150 when the piston is pushed through, so that the inside space of the mouthpiece 180 is also cleaned during the axial stroke of the piston 150 (see FIG. 4B).

According to FIG. 5, it is also conceivable to arrange the outlet bore 105B in the nozzle tip at an angle with respect to the longitudinal axis A-A of the mixing chamber, such that the longitudinal axes B-B and C-C of the outlet bores in the nozzle tips approximately intersect on the surface of piston 150, if the piston is in the operating position “mixing.” This can lead to an improved mixing result, particularly if the piston 150 has a structured surface, e.g. is provided with grooves or slots. In that case, the device can also be operated, in particular, without a stirring rod. Of course, the angled nozzle position can also be combined with the use of a stirring rod, as shown in FIGS. 1 and 2.

Since the area between mixing chamber and piston as well as piston and stirring rod should be sealed as tightly as possible, but with the lowest possible friction, it is suggested that respectively at least one of the opposite-arranged surfaces be coated with a diamond-like graphite surface coating. However, other types of surface designs are conceivable as well. Of course, material combinations with the lowest friction and wear are preferred. The piston 150 can also be provided with recesses, for example circumferential grooves, into which lubricants are packed.

In addition, several stirring rods can conceivably be used, wherein these stirring rods should always be arranged parallel to the axis A-A.

Expanding the scope of the above-described mode of operation, it is furthermore possible for the piston 150 to perform short axial strokes even during the mixing phase. As a result, oscillating pressure pulses are exerted onto the materials inside the mixing chamber 100. An axial oscillation of this type can be realized with the previously described hydraulic piston 160. However, it is also conceivable that another pneumatic or hydraulic element, operating with a short stroke, is arranged in series with the hydraulic rod 165.

In addition, more than two nozzles can also be arranged inside the mixing chamber housing 105.

1. Device for mixing viscous liquids, said device comprising:
a cylindrical mixing chamber (100) that is open on one front and contains a side wall;
at least two injection nozzles (170), the nozzle openings of which are exit bores (105B) in the side wall;
a piston (150) with circular surface, which can be displaced inside the mixing chamber (100) in axial direction along the longitudinal axis (A-A) of the mixing chamber (100),
characterized in that the piston can be rotated with a motor (135) around its longitudinal axis inside the mixing chamber (100).

2. Device according to claim 1, characterized in that the piston (150) has at least one through opening through which a stirring rod (152) extends, wherein the piston in the following (150) and the stirring rod (152) are axially uncoupled or can be uncoupled.

3. Device according to claim 1 or 2, characterized in that the axes (B-B; C-C) for the exit bores (105B) together with the longitudinal axis (A-A) of the mixing chamber (100) respectively enclose an angle ( [symbol] , [symbol] ) that is open toward one front.

4. Device according to one of the preceding claims, characterized in that the surface of the piston (150) has at least one groove.

5. Device according to one of the preceding claims, characterized in that the piston (150) is provided with undercuts.

6. Device according to claim 5, characterized in that the undercuts are filled at least in part with lubricants.

7. Device according to one of the preceding claims, characterized in that the piston (150) has a first position in which the piston does not come in contact with the nozzle openings.

8. Device according to claim 7, characterized in that the piston (150) occupies another position in which the piston does not come in contact with the nozzle openings.

9. Device according to claim 3 and claim 7 or 8, characterized in that the axes (B-B; C-C) for the exit boreholes (105B) approximately intersect on the surface if the piston (150) occupies the first or second position.

10. Device according to claim 6, characterized in that drive means are provided, which can cause the piston (150) to perform an oscillating movement between the two positions with simultaneous rotational movement of the piston.

11. Device according to claim 2, characterized in that the stirring rod (152) is connected in axial direction at least indirectly to the side wall.

12. Device according to one of the preceding claims, characterized in that the first end of a mouthpiece (180) of a flexible material is arranged on the opening to the mixing chamber (100).

13. Device according to claim 11, characterized in that the mouthpiece (180) flattens out toward its second end.

14. Device according to one of the preceding claims, characterized in that the piston and/or the side wall are provided at least partially with a carbon coating.

15. Method for mixing at least two viscous liquids by using a device with the features as defined in claim 1, said method comprising the following steps:
a) positioning of the piston in a first position, wherein the piston does not block the nozzle openings;
b) injecting the liquid with simultaneous rotation of the piston;
c) ending of the injection operation;
d) axial displacement of the piston for discharging the material remaining inside the mixing chamber.

16. Method according to claim 15, characterized in that the piston is moved in step d) far enough so that it leaves the circular area of the mixing chamber.

17. Method according to one of the claims 15 or 16, characterized in that during step b), the piston oscillates between a first position and a second position in which the piston also does not block the nozzle openings.

18. Method according to one of the claims 15 to 17, characterized in that the liquids are injected under pressures of more than 100 bar.
